(19) United States
(12) Patent Application Publication
(10) Pub. No.: US 2019/0179722 A1
(43) Pub. Date: Jun. 13, 2019

(54) TOOL FOR ENTERPRISE-WIDE SOFTWARE MONITORING

(71) Applicant: Bank of America Corporation, Charlotte, NC (US)

(72) Inventors: Nurani R. Parasuraman, Irving, TX (US); Prabhat Ranjan, Plano, TX (US); Jason Edward Collum, Fort Worth, TX (US); Ketulkumar Vinodchandra Joshi, Mumbai (IN); Geetha S. Sundaram, Frisco, TX (US); Valerie L. Perez, Menlo Park, CA (US); Joseph Anil Kumar Mendemu, Irving, TX (US)

(21) Appl. No.: 15/837,327

(22) Filed: Dec. 11, 2017

(51) Int. Cl. G06F 11/30; G06F 9/455; G06F 17/27; G06F 17/30; G06F 8/65

(52) U.S. Cl. CPC G06F 11/302; G06F 9/45558; G06F 17/2705; G06F 2009/45591; G06F 8/65; G06F 11/3051; G06F 17/30312

(57) ABSTRACT

A system executes an enterprise framework for enterprise-wide software monitoring using a Software Deployment Management (SDM) environment such as Pega®. The system accesses a plurality of virtual machines running within the enterprise; determine a plurality of applications running in each of the plurality of virtual machines; access each of the management beans provided by each of the plurality of applications in each of the plurality of virtual machines; identify each of the management beans by name and operation; parse each of the management beans to determine associated automated entity (i.e., agent and/or listener) information; and store the automated entity information in an accessible database. Each of the management beans may be accessed periodically and based on a predetermined regular time interval and/or may be accessed substantially concurrently. Likewise, each of the virtual machines may be accessed substantially concurrently. The time of access may also be stored.

### FIELD

The present invention relates to an enterprise framework for efficient software deployment.

### BACKGROUND

Today there are many steps application developers must complete to deploy certain software within an entity. There is a need for developing and deploying a framework for automating and simplifying the process.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Embodiments of the present invention address the above needs and/or achieve other advantages by providing apparatuses (e.g., a system, computer program product and/or other devices) and methods for executing an enterprise framework for efficient software deployment using a Software Deployment Management (SDM) environment such as Pega®. The system embodiments may comprise one or more memory devices having computer readable program code stored thereon, a communication device, and one or more processing devices operatively coupled to the one or more memory devices.

According to embodiments of the invention, a system for enterprise-wide software monitoring using a Software Deployment Management (SDM) environment includes one or more memory devices; one or more processing devices operatively coupled with the one or more memory devices, wherein the processing device is configured to execute computer-readable program code to access a plurality of virtual machines running within the enterprise; determine a plurality of applications running in each of the plurality of virtual machines; access each of the management beans provided by each of the plurality of applications in each of the plurality of virtual machines; identify each of the management beans by name and operation; parse each of the management beans to determine associated automated entity information; and store the automated entity information in an accessible database.

In some embodiments, the processing device is further configured to execute computer-readable program code to parse each of the management beans to determine associated automated agent information.

In some embodiments, the processing device is further configured to execute computer-readable program code to parse each of the management beans to determine associated automated listener information.

In some embodiments, the processing device is further configured to execute computer-readable program code to access each of the management beans periodically and based on a predetermined regular time interval.

In some embodiments, the processing device is further configured to execute computer-readable program code to access each of the management beans substantially concurrently.

In some embodiments, the processing device is further configured to execute computer-readable program code to access each of the virtual machines substantially concurrently.

In some embodiments, the processing device is further configured to execute computer-readable program code to for each of the management beans accessed, store information indicating a time of access with the automated entity information.

According to embodiments of the invention, a computer program product for enterprise-wide software monitoring using a Software Deployment Management (SDM) environment includes at least one non-transitory computer readable medium including computer readable instructions. The instructions include an executable portion to access a plurality of virtual machines running within the enterprise; an executable portion to determine a plurality of applications running in each of the plurality of virtual machines; an executable portion to access each of the management beans provided by each of the plurality of applications in each of the plurality of virtual machines; an executable portion to identify each of the management beans by name and operation; an executable portion to parse each of the management beans to determine associated automated entity information; and an executable portion to store the automated entity information in an accessible database.

In some embodiments, the computer readable instructions further comprise an executable portion to parse each of the management beans to determine associated automated agent information.

In some embodiments, the computer readable instructions further comprise an executable portion to parse each of the management beans to determine associated automated listener information.

In some embodiments, the computer readable instructions further comprise an executable portion to access each of the management beans periodically and based on a predetermined regular time interval.

In some embodiments, the computer readable instructions further comprise an executable portion to access each of the management beans substantially concurrently.

In some embodiments, the computer readable instructions further comprise an executable portion to access each of the virtual machines substantially concurrently.

In some embodiments, the computer readable instructions further comprise an executable portion to, for each of the management beans accessed, store information indicating a time of access with the automated entity information.

According to embodiments of the invention, a computer implemented method for enterprise-wide software monitoring using a Software Deployment Management (SDM) environment includes accessing a plurality of virtual machines running within the enterprise; determining a plurality of applications running in each of the plurality of virtual machines; accessing each of the management beans provided by each of the plurality of applications in each of the plurality of virtual machines; identifying each of the management beans by name and operation; parsing each of the management beans to determine associated automated entity information; and storing the automated entity information in an accessible database.

In some embodiments, the method includes parsing each of the management beans to determine associated automated agent information.

In some embodiments, the method includes parsing each of the management beans to determine associated automated listener information.

In some embodiments, the method includes accessing each of the management beans periodically and based on a predetermined regular time interval.

In some embodiments, the method includes accessing each of the management beans substantially concurrently; and accessing each of the virtual machines substantially concurrently.

In some embodiments, for each of the management beans accessed, the method includes storing information indicating a time of access with the automated entity information.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, where:

FIG. 1 illustrates a block diagram illustrating an environment in which embodiments of the invention operate, in accordance with embodiments of the present invention.

FIG. 2 illustrates an entity relationship diagram for agent monitoring according to embodiments of the invention.

FIGS. 3A and 3B illustrate methods for agent monitoring according to embodiments of the invention.

FIG. 4 illustrates a general process flow 400, for enterprise-wide software monitoring according to embodiments of the invention.

FIG. 5 illustrates an entity relationship diagram for listener monitoring according to embodiments of the invention.

FIGS. 6A and 6B illustrate methods for listener monitoring according to embodiments of the invention.

FIGS. 7A-7G illustrate flowcharts for software monitoring reporting according to embodiments of the invention.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

To “monitor” is to watch, observe, or check something for a special purpose over a period of time. The “monitoring” may occur periodically over the period of time, or the monitoring may occur continuously over the period of time. In some embodiments, a system may actively monitor a database, wherein the system reaches out to the database and watches, observes, or checks the database for changes, updates, and the like. In other embodiments, a system may passively monitor a database, wherein the database provides information to the system and the system then watches, observes, or checks the provided information. To “maintain” or to provide “maintenance” is to manage, update, or retain something. In some embodiments “maintaining” may include housing or storing a database or server on hardware and/or software associated with a maintaining entity. In some embodiments, “maintaining” may further comprise applying software updates or applying patches to a server or database.

Today there are many steps administrators must complete to monitor software within an entity. There is a need for developing and deploying a framework for automating and simplifying the process. An example of such software is the Pega® Platform, which is provided by Pegasystems Inc. of Boston, Mass. It provides for an adaptive, cloud-architected software that empowers people to rapidly deploy, and easily extend and change application to meet strategic business needs, providing capabilities in content and resource management and business process management (BPM). This software functions to automate the workflow of tasks, building and delivering software.

Embodiments of the present invention provide for enterprise-wide software monitoring using BPM software, such as the Pega® solution noted above. Embodiments provide efficiency improvements over traditional software deployment processes by automating numerous steps and eliminating the need for human input for various steps in the software monitoring process.

Today there are many steps application developers must complete to deploy certain software within an entity. There is a need for developing and deploying a framework for automating and simplifying the process. An example of such software is the Pega® Platform, which is provided by Pegasystems Inc. of Boston, Mass. It provides for an adaptive, cloud-architected software that empowers people to rapidly deploy, and easily extend and change application to meet strategic business needs, providing capabilities in content and resource management and business process management (BPM). This software functions to automate the workflow of tasks, building and delivering software.

The problem statement for embodiments of the invention is that the Pega® platform does not support the level of monitoring required by some entities, such as banks. Embodiments of the invention, therefore, provide a tool to provide details on Pega® performance. The solution is implemented without adding overhead to the Pega® platform. Additionally, no listener monitoring functionality exists today with other Pega® solutions.

Embodiments of the invention solve these and other problems by providing a system that executes an enterprise framework for enterprise-wide software monitoring using a Software Deployment Management (SDM) environment such as Pega®. The system accesses a plurality of virtual machines running within the enterprise; determine a plurality of applications running in each of the plurality of virtual machines; access each of the management beans provided by each of the plurality of applications in each of the plurality of virtual machines; identify each of the management beans by name and operation; parse each of the management beans to determine associated automated entity (i.e., agent and/or listener) information; and store the automated entity information in an accessible database. Each of the management beans may be accessed periodically and based on a predetermined regular time interval and/or may be accessed substantially concurrently. Likewise, each of the virtual machines may be accessed substantially concurrently. The time of access may also be stored.

More specifically, embodiments of the invention gather management bean (MBean) information from Pega® through a Web Sphere® application and integration middleware provided by IBM. This occurs across all JAVA Virtual Machines (JVMs or VMs) and multiple servers connected with the system at the same or substantially the same time.

Automated jobs in Pega® are called Agents. There are agents that run in the background for the Pega® Engine. These are called Out of the Box and can be noted in Rulesets that start with Pega. Just about every Pega® application has at least one agent to handle one or more background tasks. Pega® provides a tool (System Management Application—SMA) to review the agents, as well as other aspects, of Pega® applications on each JVM. Each JVM node is setup, made available, and individually accessible in SMA. This can take several minutes to review all of the JVMs and the agents running on them.

With the number of Pega® applications and the number of JVMs running the Pega® applications, a process needs to be created to monitor the agents across the Pega® Platform. Discussions of the various Phases of product innovation discussed below provide details on the means to obtain agent information and provide an interface to review the comparison results.

The First Phase of agent monitoring is SMA Automation. Automating gathering data and comparing to a baseline has historically been difficult to complete manually as the Pega® Platform has grown. Embodiments of the present invention provide a macro-based Excel spreadsheet to sequentially access a Pega® SMA URL and node from a list and gather agent information from SMA. This data is compared to a copy of the agent information that represents a baseline. In various embodiments, this process includes manual steps and can take approximately three (3) to five (5) minutes. The baseline is not necessarily centralized and could easily become out dated and/or out of synchronicity with other elements of the environment.

The Second Phase of agent monitoring is MBean Gathering Automation. SMA provides the information made available in Management or Managed Beans (MBeans) managed by Pega®. Embodiments of the invention access and leverage the same information without requiring loading of SMA. Embodiments may access and store the desired information at a regular scheduled interval, so that administrators desiring up-to-date information on the agents can simply access the database in which the information is stored.

As noted above, the Web Sphere® (provided by IBM) middleware platform provides a means to access the JVMs and the Management Beans provided by applications running in the JVM. Utilizing this means and identifying the Management Bean by name and/or operation, embodiments of the invention obtain the agent information and store it in a centralized database quickly and automatically.

The Third Phase of agent monitoring is Reporting and Management. Once the agent information has been obtained on a regular basis, a set of reports can be generated to indicate areas of concern. A web based interface can be provided to manage the baseline information for agents. The interface enables administrators to add, update, and remove agent baseline information.

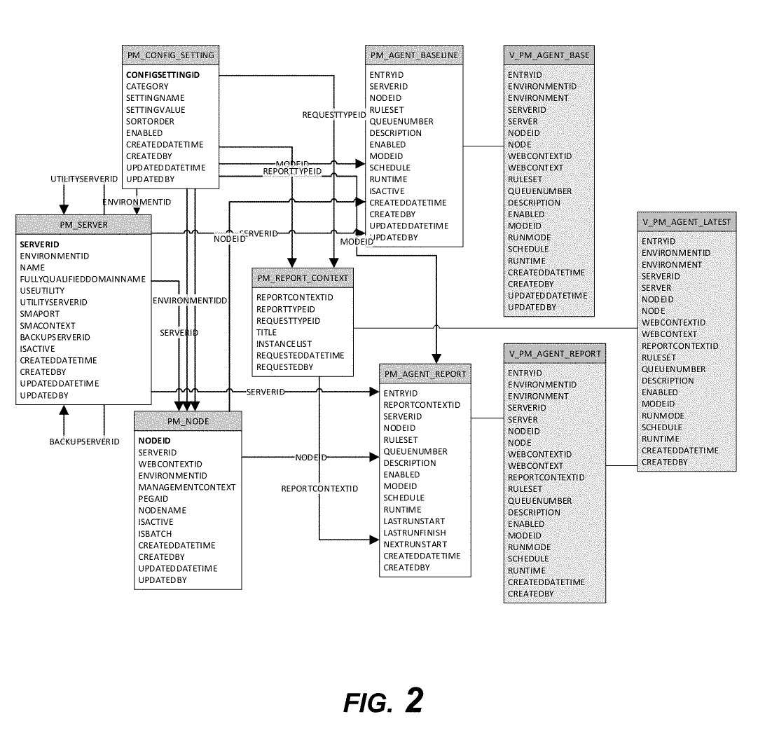

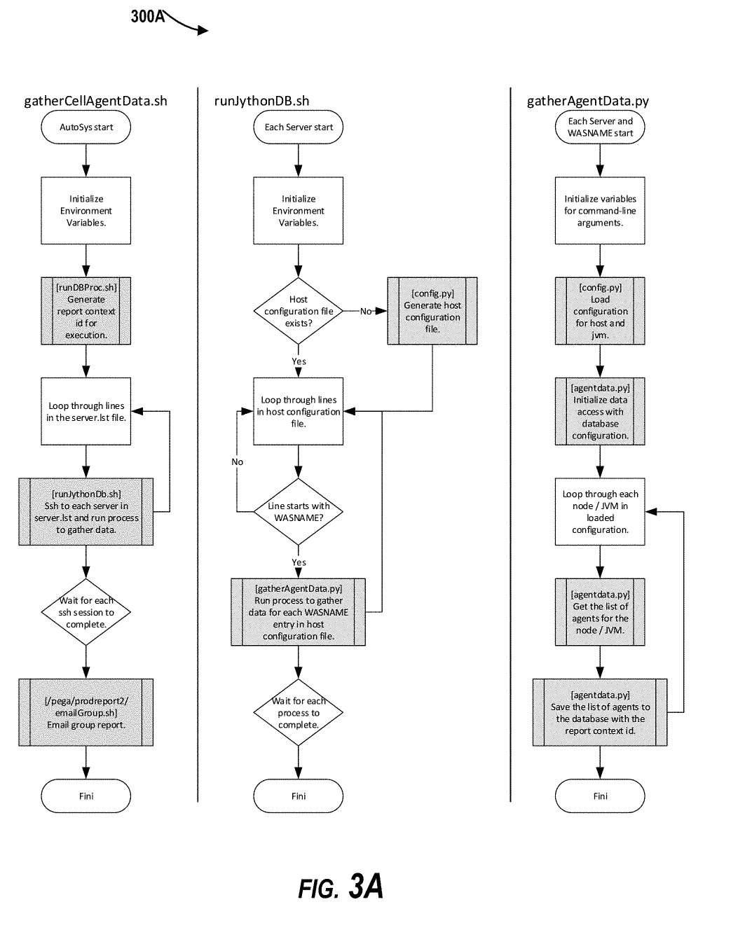

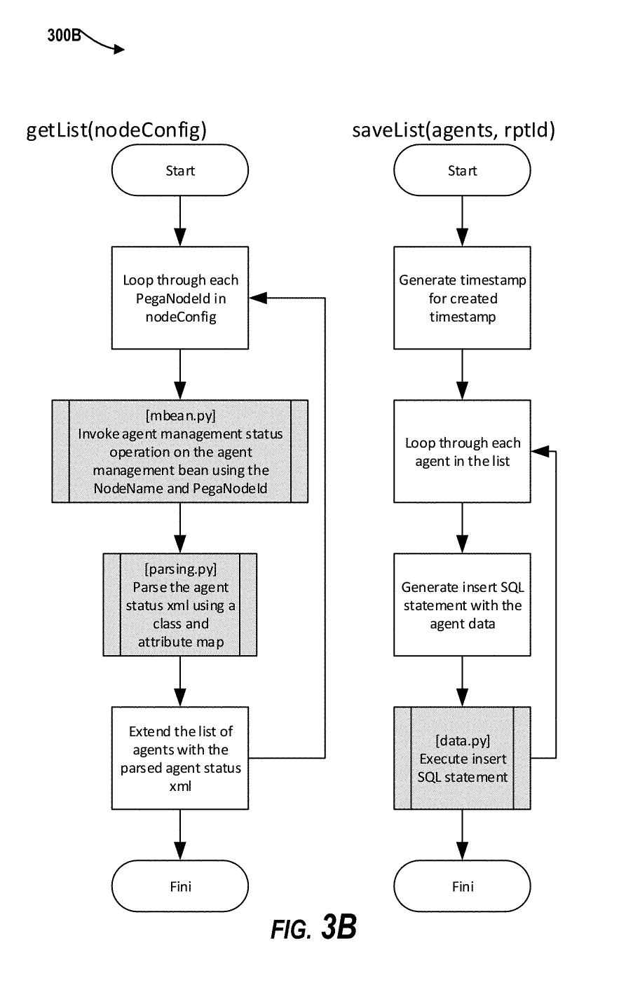

Referring now to FIG. 2, agent data gathering is illustrated by an MBean entity relationship diagram. Referring to FIG. 3A, a process flow for gathering agent information is shown. “mbean.py” is a module of functions to access management beans within the WebSphere® platform. “parsing.py” is a module of functions to parse XML of the MBean into a list of objects using defined dictionary maps. “config.py” is a module of functions to generate and load the configuration settings for the data gathering process. “dbconfig.py” is a class that represents the database configuration settings. “data.py” is a class that represents the data access process. Referring to FIG. 3B, a process flow represents the “agentdata.py” class referenced in the flow of FIG. 3A. The “agentdata.py” class represents the data access process specifically for agent information. “agent.py” is a class that represents agent information. “gatherAgentData.py” is a module to initialize and run through the configuration settings to gather the agent information and store it in the database. “runJythonDb.sh” is a shell script to setup the environment variables and run the “gatherAgentData.py” process in Web Sphere® on each network system of the entity. “gatherCellAgentData.sh” is a shell script to setup the environment variables and gather agent information from each network system of the entity.

Embodiments of the invention also provide for preparation of Agent Monitoring Reports. Reports are generated after data is gathered at each interval. When specific situations arise, some maintenance is required. One function is Adding New Applications. When the data gathering process runs and inserts the agent data into the database, the procedures will create new server and node records as needed. The new server and node records (Table: PM_SERVER and Table: PM_NODE) will be set to an unknown environment and an unassigned web context.

If the environment configuration setting record does not exist, the system will create it and ensure that the configuration setting record is enabled (Table: PM_CONFIG_SETTING; Category: ENVIRONMENT).

If the web context configuration setting record(s) do not exist, it or they will be created. If there are more than one web context to be created, the system may keep the configuration setting name the same for each web context and have the configuration setting value represent the different contexts. The system may also ensure that the configuration setting record(s) are enabled (Table: PM_CONFIG_SETTING; Category: WEBCONTEXT).

If the AIT-application map record has not been created, the system creates it. The system may also set the instance column value to match the web context configuration setting name (Table: PM_AIT_APP_MAP).

After these records have been created, the system updates the new server and node records to the appropriate environment configuration setting ID and web context configuration setting ID.

Embodiments of the invention also provide for Pega® Listener Monitoring. Automated processes that wait for an event to occur in Pega® are called Listeners. There are several types of listeners for which Pega® provides a template. The top listeners a Pega® application may configure are File, Email, JMS, and JMS MDB. Pega® provides a tool (System Management Application—SMA) to review the listeners, as well as other aspects, of Pega® applications on each JVM. Each JVM node is setup, made available, and individually accessible in SMA. As with agents, this can take several minutes to review all of the JVMs and the listeners running on them. With the number of Pega® applications and the number of JVMs running the Pega® applications, embodiments of the invention provide an efficient system for monitoring the listeners across the Pega® Platform. Embodiments of the invention obtain listener information and provide an administrator interface to review the comparison results.

The First Phase of listener monitoring is Phase 1—MBean Gathering Automation. As with agent monitoring discussed above, SMA provides the information made available in Management Beans managed by Pega. Embodiments of the invention enable gathering the same information without loading SMA and at a regularly scheduled interval, thereby enabling up-to-date listener monitoring.

As noted above, IBM's WebSphere® platform provides a means to access the JVMs and the Management Beans provided by applications running in the JVM. Utilizing this means and identifying the Management Bean name and/or operation, it is possible to obtain the listener information and store it in a centralized database quickly and automatically.

The Second Phase of listener monitoring is Listener Monitoring Reporting and Management. Once the listener information has been obtained on a regular basis, a set of reports can be generated to indicate areas of concern. A web based interface can be provided to manage the baseline information for listeners and may include functionality such as Add, update, and remove listener baseline information.

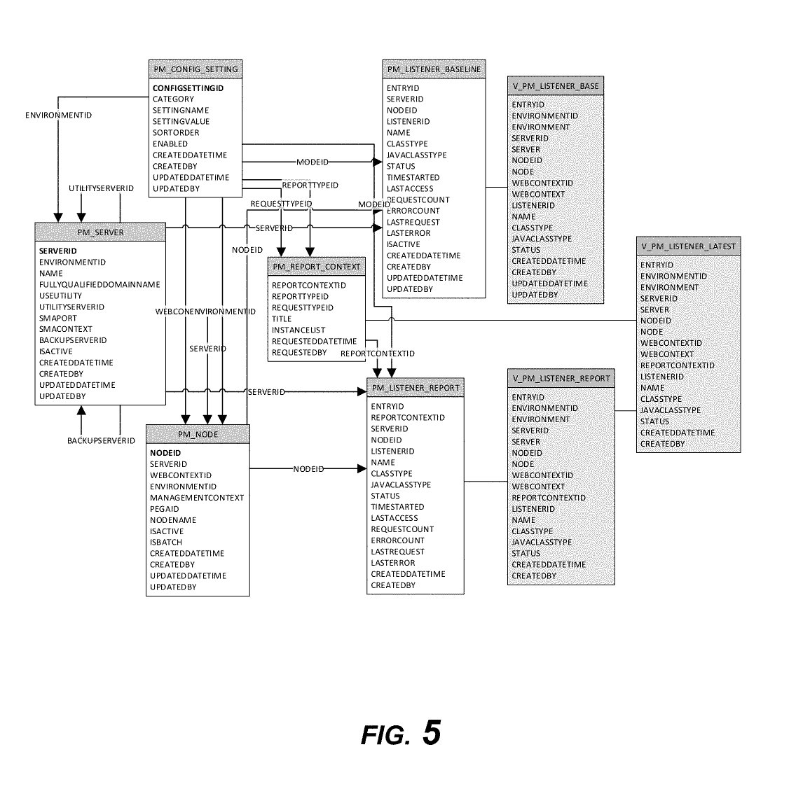

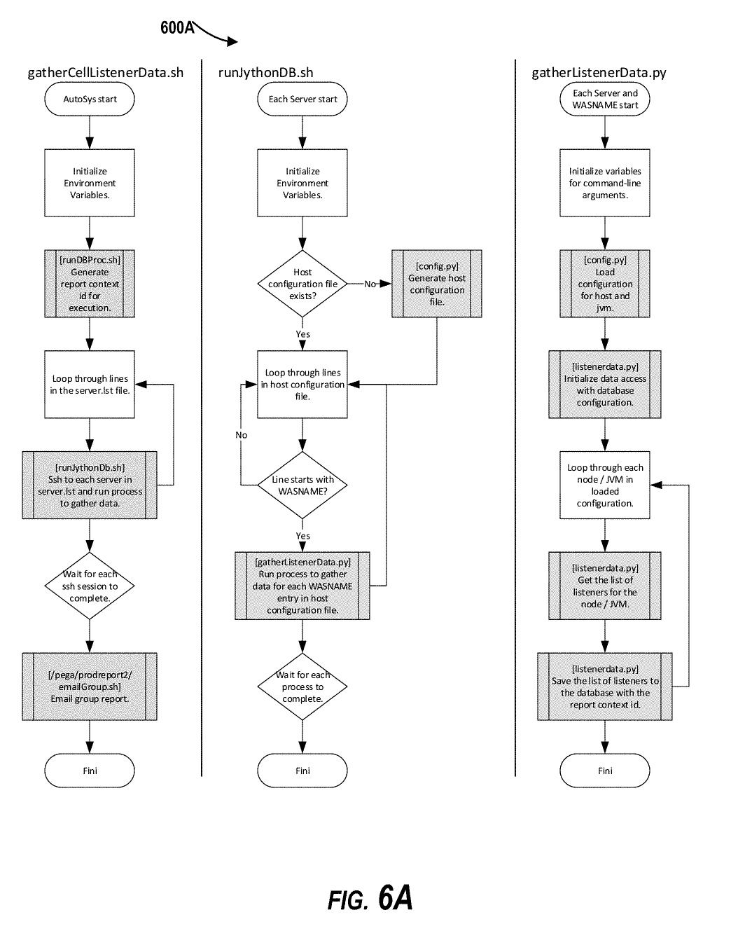

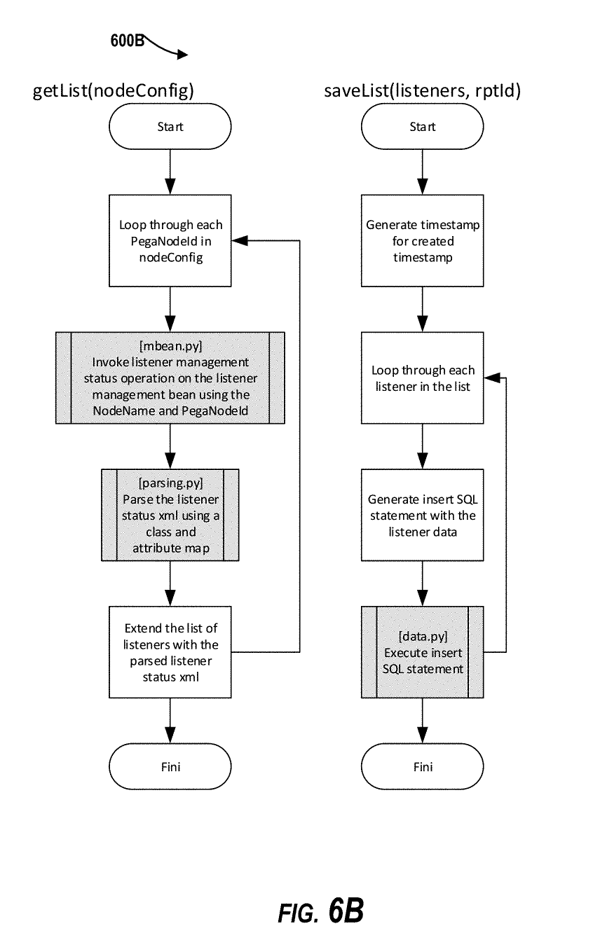

Referring now to FIG. 5, an Entity Relationship Diagram illustrates the listener data gathering process using management beans. FIG. 6A shows a process for “mbean.py”, which is a module of functions to access management beans using the WebSphere® platform. “parsing.py” is a module of functions to parse XML into a list of objects using defined dictionary maps. “config.py” is a module of functions to generate and load the configuration settings for the data gathering process. “dbconfig.py” is a class that represents the database configuration settings. “data.py” is a class that represents the data access process.

FIG. 6B shows “listenerdata.py”, which is a class that represents the data access process specifically for listener information. “listener.py” is a class that represents listener information. “gatherListenerData.py” is a module to initialize and run through the configuration settings to gather the listener information and store it in the database. “runJythonDb.sh” is a shell script to setup the environment variables and run the “gatherListenerData.py” process in the WebSphere® platform on each networked system. “gatherCellListenerData.sh” is a shell script to setup the environment variables and gather listener information from each networked system.

Embodiments of the invention also enable Listener Monitoring Reports. The system may generate reports after data is gathered at each regular interval. When specific situations arise, some maintenance may be required. For example, the system may need to add new applications. When the data gathering process runs and inserts the listener information into the database, the system creates new server and node records as needed. The new server and node records will be set to an unknown environment and an unassigned web context. (Table: PM_SERVER; Table: PM_NODE). If the environment configuration setting record does not exist, the system will create it and ensure the configuration setting record is enabled. (Table: PM_CONFIG_SETTING; Category: ENVIRONMENT). If the web context configuration setting record(s) do not exist, it or they will be created. If there are more than one web context to be created, the system may keep the configuration setting name the same for each web context and have the configuration setting value represent the different contexts. The system will ensure the configuration setting record(s) are enabled. (Table: PM_CONFIG_SETTING; Category: WEBCONTEXT). If the AIT-application map record has not been created, it will be created. The system will set the instance column value to match the web context configuration setting name. (Table: PM_AIT_APP_MAP). After these records have been created, the system updates the new server and node records to the appropriate environment configuration setting ID and web context configuration setting ID.

Embodiments of the invention also provide for Automated System Reporting. Reporting around system level information requires automation and scheduling. System level reports include Pega® Agent System Queue monitoring, Requestor count and clipboard monitoring, Pega® Application work monitoring, BIX Extract trending, etc. Automated Reporting needs to be flexible due to multiple versions of Pega® running. The automation needs to be flexible to provide efficient and meaningful information. The automated reports may need to be different for each Pega® instance or application. Automated reports may require highlighting areas of concern or interest. Highlighting criteria will need to be flexible and applicable to the associated report.

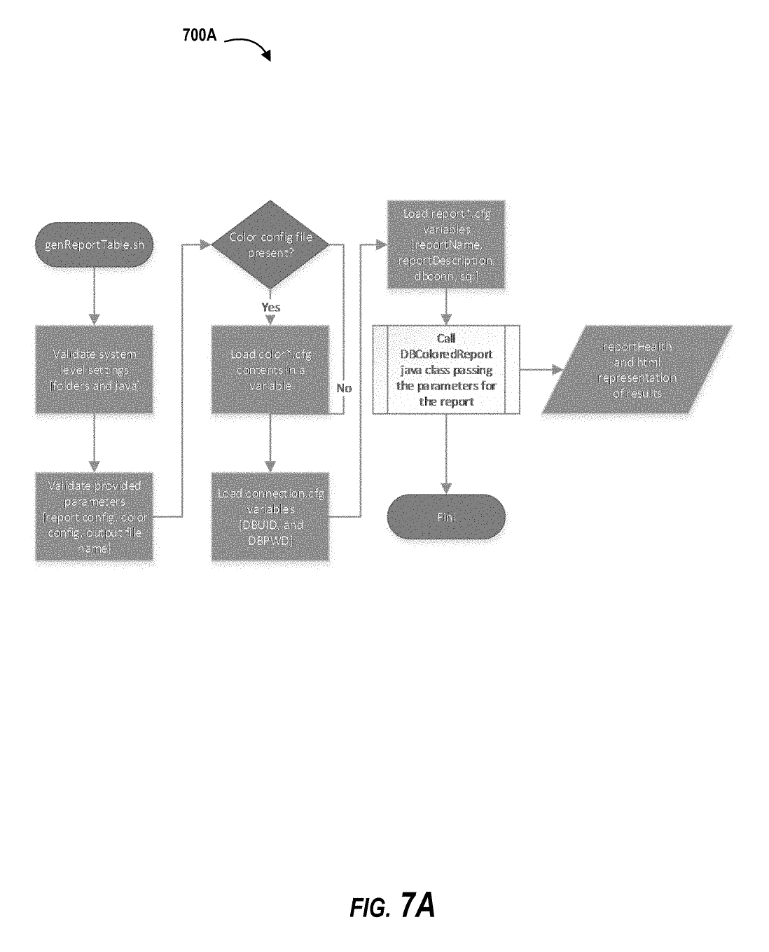

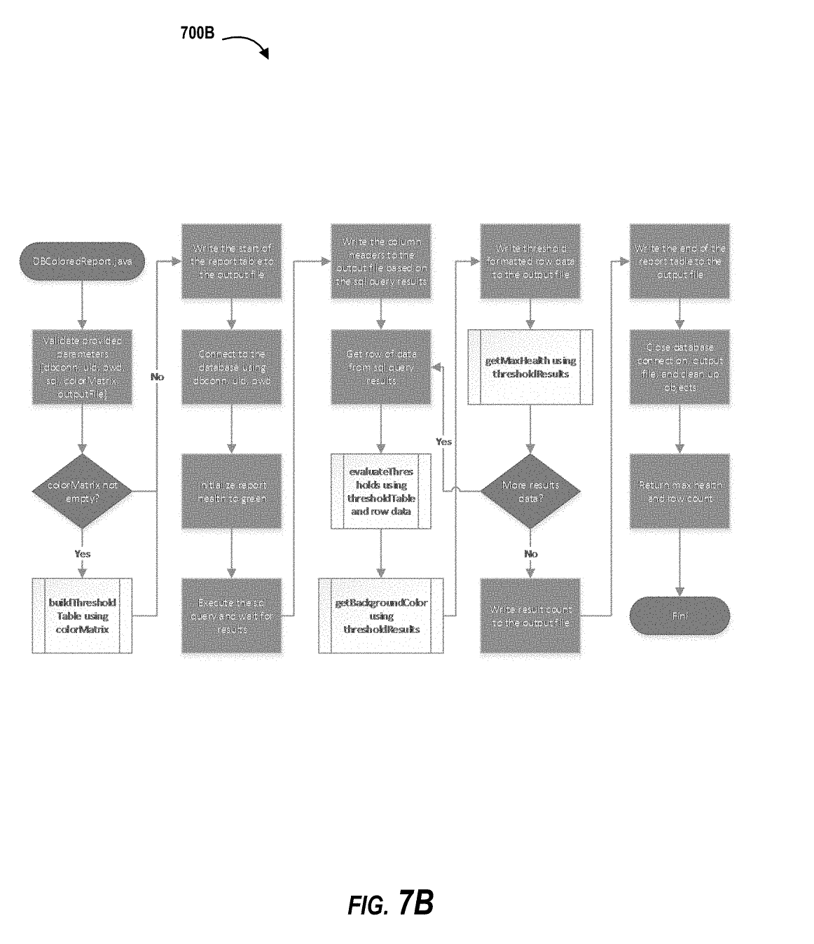

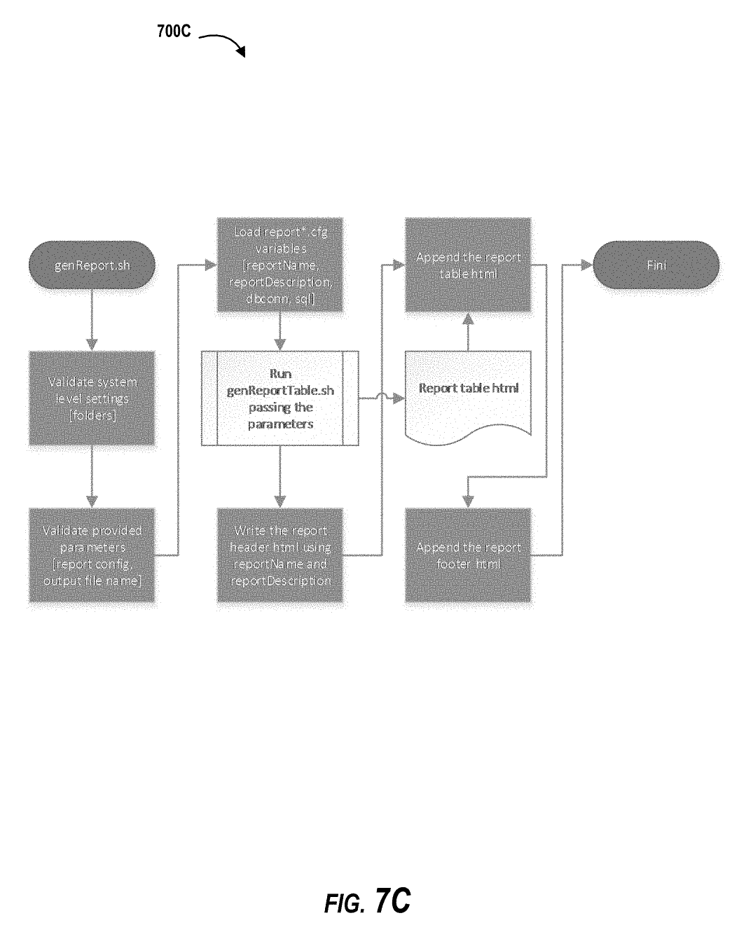

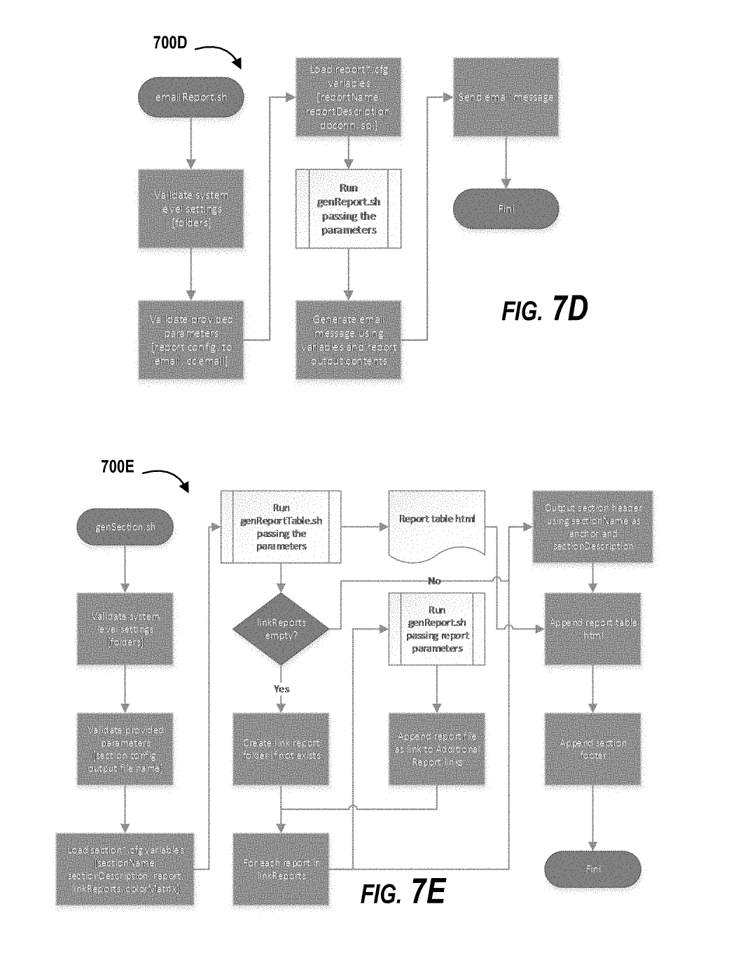

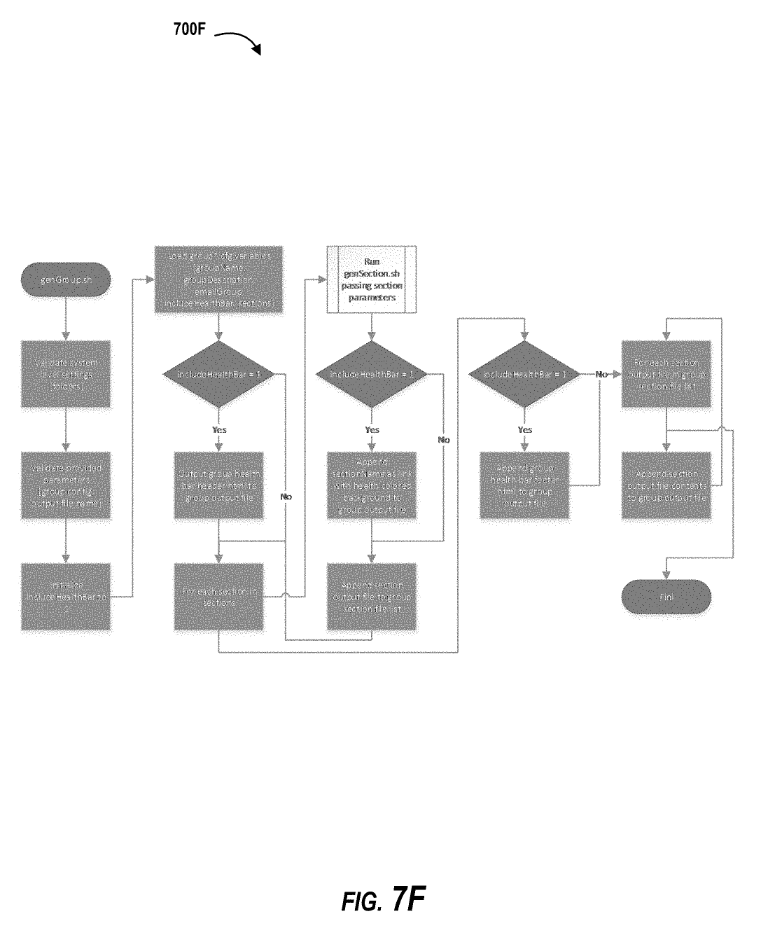

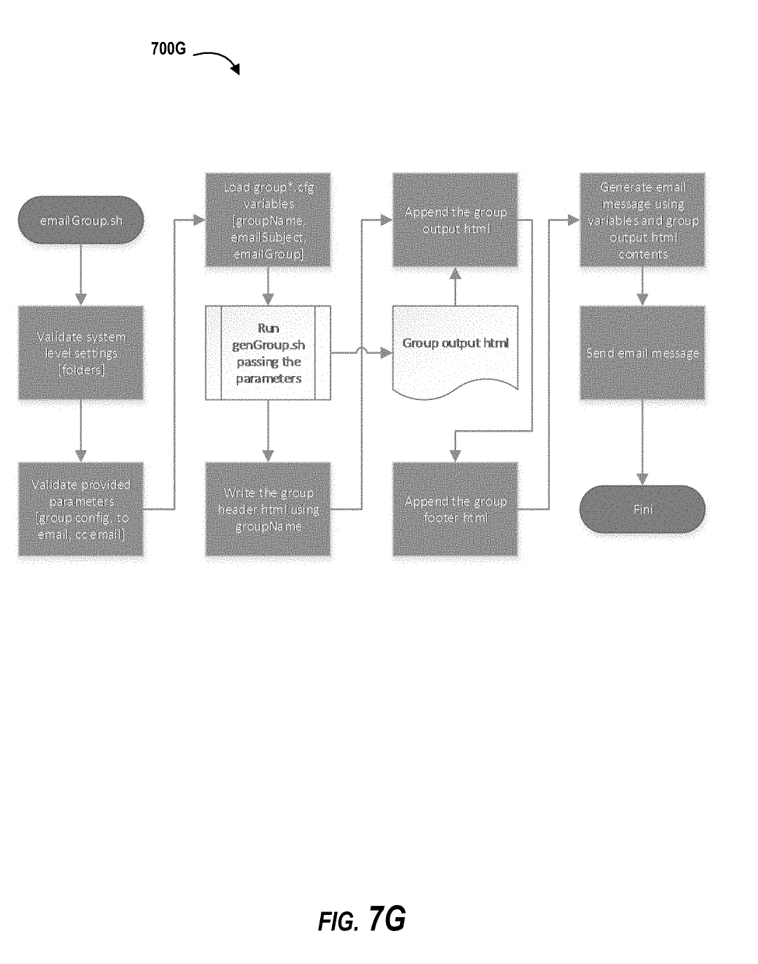

Referring to FIG. 7A, a flowchart illustrates the “genReportTable.sh”, which is a shell script to set environment variables and execute a Java class to execute a SQL statement and generate an HTML table. Elements include the report configuration value—information to identify a report configuration file (report*.cfg), an optional color matrix configuration value—information to identify a color configuration file (color*.cfg), and an optional report table file name—file name to store the SQL results as an HTML table.

Referring to FIG. 7B, a flowchart illustrates the “DBColoredReport.java”, which is a java class to execute a SQL statement and generate an HTML table. If a criteria matrix is provided, the system applies it to the SQL statement results while generating the HTML table. Elements include the DB connection URL—database connection URL, DB user id—database connection user id, DB password—database connection password, SQL—SQL statement to execute for the report, and a color matrix criteria—contents of a color configuration file. If a color matrix criteria configuration is not required for report, the system passes an empty string (“ ”) for this parameter. Elements also include an output file name—file name to store the SQL results as an HTML table. “Threshold.java” is a Java class to parse and evaluate a criteria matrix on result row data. “Criteria.java” is a Java class to parse and evaluate one criterion from a criteria matrix. “ThresholdResult.java” is a Java class to parse and represent the result to return if criteria are true. “Health.java” is a Java class to represent a health level/color. It provides a value to the health level/color in order to identify the maximum health level for the SQL results where a criteria matrix is provided. “report*.cfg” is a configuration file defining variables representing the report. “reportName” is the name of the report. “reportDescription” is the description of the report. “dbconn” is the database connection URL for executing the SQL statement. “sql” is the SQL statement to execute for the report. “color*.cfg” is the configuration file containing the criteria and result to be applied to SQL results while generating an HTML table. (column name,>,value;column name,=,value; . . . |column name,result (color); column name,=,value|column name,result (color); . . . ). “connection.cfg” is a configuration file defining the user id and password to connect to all report database connection URLs.

Embodiments of the invention also enable generating an HTML Report from SQL Statement as shown in FIG. 7C, generating an Email HTML report as shown in FIG. 7D, generating an HTML section as shown in FIG. 7E, and generating a group of HTML sections as shown in FIG. 7F.

In summary, embodiments of the invention provide a system for enterprise-wide software monitoring using a Software Deployment Management (SDM) environment such as Pega®.

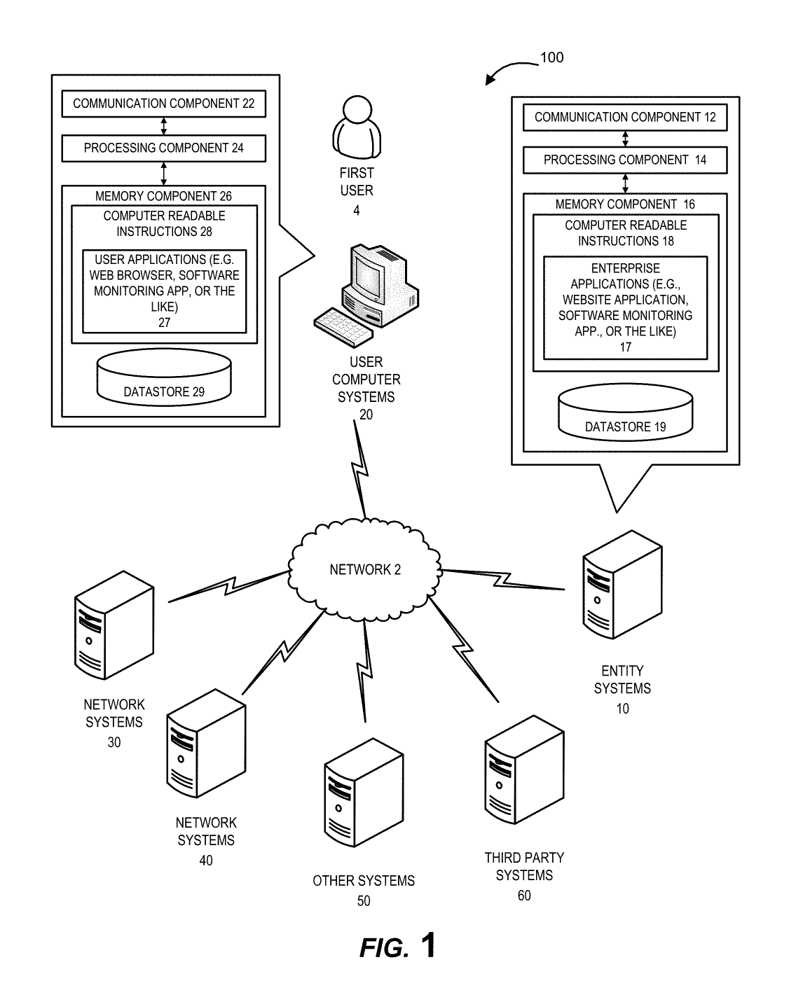

Referring now to FIG. 1, many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more resources or portions of a resource. Furthermore, as used herein, the term “user computing device” or “mobile device” may refer to mobile phones, personal computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

A “system environment”, as used herein, may refer to any information technology platform of an enterprise (e.g., a national or multi-national corporation) and may include a multitude of servers, machines, mainframes, personal computers, network devices, front and back end systems, database system and/or the like.

FIG. 1 illustrates a system and environment 100 for executing an enterprise-wide software monitoring, in accordance with embodiments of the invention. As illustrated in FIG. 1, one or more entity systems 10 are operatively coupled, via a network 2, to user computer systems 20, network systems 30, network systems 40, other systems 50, and third party systems 60. In this way, the user 4 (e.g., one or more associates, employees, agents, contractors, sub-contractors, third-party representatives, customers, or the like), through a user application 27 (e.g., web browser, software monitoring application, or the like), may access enterprise applications 17 (e.g., website, software monitoring application, or the like) of the entity systems 10 to manage the software monitoring discussed herein. In some embodiments, the software monitoring application may be a part of an independent system or environment.

In some embodiments, the network systems 30, the network systems 40, the other systems 50, and the third party systems 60 may be a part of the entity systems 10. The network systems 30, the network systems 40, the other systems 50, and the third party systems 60 may comprise one or more processing devices operatively coupled to the one or more memory devices and configured to execute computer readable code stored in the one or more memory devices. In some embodiments, the network systems 30, the network systems 40, the other systems 50, and the third party systems 60 may be a part of single environment system, wherein the single environment system may be maintained by the entity systems 10.

The network 2 may be a global area network (GAN), such as the Internet, a wide area network (WAN), a local area network (LAN), or any other type of network or combination of networks. The network 2 may provide for wireline, wireless, or a combination of wireline and wireless communication between systems, services, components, and/or devices on the network 2.

As illustrated in FIG. 1, the entity systems 10 generally comprise one or more communication components 12, one or more processing components 14, and one or more memory components 16. The one or more processing components 14 are operatively coupled to the one or more communication components 12 and the one or more memory components 16. As used herein, the term “processing component” generally includes circuitry used for implementing the communication and/or logic functions of a particular system. For example, a processing component 14 may include a digital signal processor component, a microprocessor component, and various analog-to-digital converters, digital-to-analog converters, and other support circuits and/or combinations of the foregoing. Control and signal processing functions of the system are allocated between these processing components according to their respective capabilities. The one or more processing components 14 may include functionality to operate one or more software programs based on computer-readable instructions 18 thereof, which may be stored in the one or more memory components 16.

The one or more processing components 14 use the one or more communication components 12 to communicate with the network 2 and other components on the network 2, such as, but not limited to, the components of the user computer systems 20, the network systems 30, the network systems 40, the other systems 50, and the third party systems 60. As such, the one or more communication components 12 generally comprise a wireless transceiver, modem, server, electrical connection, electrical circuit, or other component for communicating with other components on the network 2. The one or more communication components 12 may further include an interface that accepts one or more network interface cards, ports for connection of network components, Universal Serial Bus (USB) connectors and the like. In one embodiment of the present invention, the one or more processing components 14 automatically implement one or more automated counter measures to mitigate impact of the one or more exposures.

As further illustrated in FIG. 1, the entity systems 10 comprise computer-readable instructions 18 stored in the memory component 16, which in one embodiment includes the computer-readable instructions 18 of the entity application 17 (e.g., website application, software monitoring application, or the like). In some embodiments, the one or more memory components 16 include one or more data stores 19 for storing data related to the entity systems 10, including, but not limited to, data created, accessed, and/or used by the entity application 17 and/or the agent and/or listener information gathered according to embodiments of the invention.

Referring back to FIG. 1, users 4 may access the entity application 17, or other applications, through a user computer system 20. The user computer system 20 may be a desktop, mobile device (e.g., laptop, smartphone device, PDA, tablet, or other mobile device), or any other type of computer that generally comprises one or more communication components 22, one or more processing components 24, and one or more memory components 26.

The one or more processing components 24 are operatively coupled to the one or more communication components 22 and the one or more memory components 26. The one or more processing components 24 use the one or more communication components 22 to communicate with the network 2 and other components on the network 2, such as, but not limited to, the user computer systems 20, a plurality of user computer systems 30, and/or other systems. As such, the one or more communication components 22 generally comprise a wireless transceiver, modem, server, electrical connection, or other component for communicating with other components on the network 2. The one or more communication components 22 may further include an interface that accepts one or more network interface cards, ports for connection of network components, Universal Serial Bus (USB) connectors and the like. Moreover, the one or more communication components 22 may include a keypad, keyboard, touch-screen, touchpad, microphone, mouse, joystick, other pointer component, button, soft key, and/or other input/output component(s) for communicating with the users 4. In some embodiments of the present invention, the software monitoring application in the user computer systems 20 and the plurality of user computer systems 30 may enable a software monitoring interface to display information associated with the gathering of agent/listener data or review and analytics of the gathered data.

As illustrated in FIG. 1, the user computer systems 20 may have computer-readable instructions 28 stored in the one or more memory components 26, which in one embodiment includes the computer-readable instructions 28 for user applications 27, such as software monitoring application (e.g., apps, applet, or the like), portions of software monitoring application, a web browser or other apps that allow the user 4 to take various actions, including allowing the user 4 to access applications located on other systems, or the like. The plurality of user computer systems 30 associated with a plurality of user 5 may include similar structure as that of the user computer systems 20.

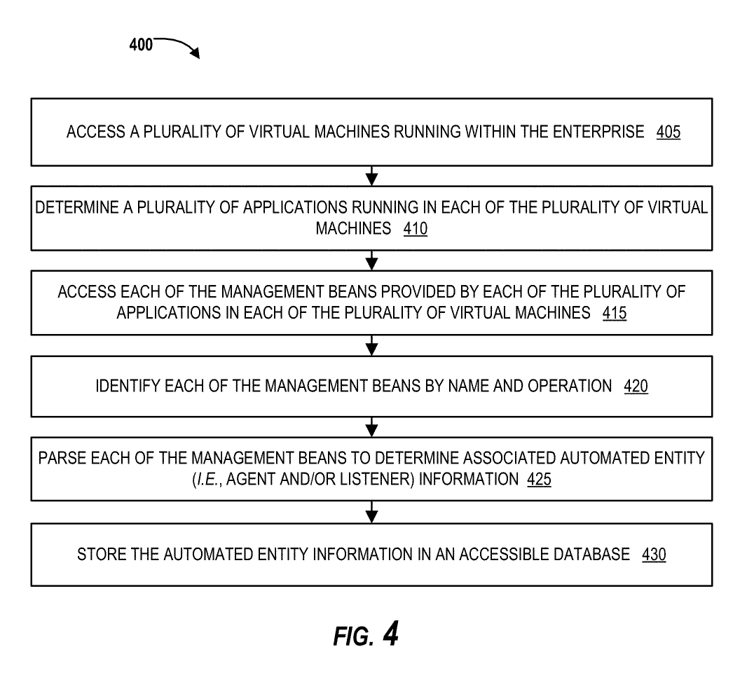

Referring now to FIG. 4, a flowchart 400 illustrates a method for enterprise-wide software monitoring according to embodiments of the invention. The first step, as represented by block 405, is for the system to access a plurality of virtual machines running within the enterprise. Next, as represented by block 410, is for the system to determine a plurality of applications running in each of the plurality of virtual machines. Then, as represented by block 415, is for the system to access each of the management beans provided by each of the plurality of applications in each of the plurality of virtual machines. The next step, as represented by block 420, is the system identifying each of the management beans by name and/or operation. Then, as represented by block 425, is that the system parses each of the management beans to determine associated automated entity information. The automated entity may be or include one or more of an agent and/or a listener within the Pega® environment.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein. In some embodiments, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

1. A system for enterprise-wide software monitoring using a Software Deployment Management (SDM) environment, the system comprising:
one or more memory devices;
one or more processing devices operatively coupled with the one or more memory devices, wherein the processing device is configured to execute computer-readable program code to:
access a plurality of virtual machines running within the enterprise;
determine a plurality of applications running in each of the plurality of virtual machines;
access each of a plurality of management beans provided by each of the plurality of applications in each of the plurality of virtual machines, wherein the management beans store information related to the automated agents and automated listeners of the plurality of applications;
identify each of the management beans by name and operation;
parse each of the management beans to determine associated automated agent information and automated listener information, wherein automated agent information is information related to automated background tasks occurring within the applications and automated listener information is information related to automated processes that wait for an event to occur; and
store the automated agent information and automated listener information in an accessible database,
wherein the management beans are accessed and the automated agent information and automated listener information is determined absent loading of a Systems Management Application (SMA) of the SDM.

2-3. (canceled)

4. The system of claim 1, wherein the processing device is further configured to execute computer-readable program code to:
access each of the management beans periodically and based on a predetermined regular time interval.

5. The system of claim 1, wherein the processing device is further configured to execute computer-readable program code to:
access each of the management beans concurrently.

6. The system of claim 1, wherein the processing device is further configured to execute computer-readable program code to:
access each of the virtual machines concurrently.

7. The system of claim 1, wherein the processing device is further configured to execute computer-readable program code to:
for each of the management beans accessed, store information indicating a time of access with the automated agent information and automated listener information.

8. A computer program product for enterprise-wide software monitoring using a Software Deployment Management (SDM) environment, wherein the computer program product comprises at least one non-transitory computer readable medium comprising computer readable instructions, the instructions comprising:
an executable portion to access a plurality of virtual machines running within the enterprise;
an executable portion to determine a plurality of applications running in each of the plurality of virtual machines;
an executable portion to access each of a plurality of management beans provided by each of the plurality of applications in each of the plurality of virtual machines, wherein the management beans store information related to the automated agents and automated listeners of the plurality of applications;
an executable portion to identify each of the management beans by name and operation;
an executable portion to parse each of the management beans to determine associated automated agent information and automated listener information, wherein automated agent information is information related to automated background tasks occurring within the applications and automated listener information is information related to automated processes that wait for an event to occur; and
an executable portion to store the automated agent information and automated listener information in an accessible database,
wherein the management beans are accessed and the automated agent information and automated listener information is determined absent loading of a Systems Management Application (SMA) of the SDM.

9-10. (canceled)

11. The computer program product of claim 8, wherein the computer readable instructions further comprise:
an executable portion to access each of the management beans periodically and based on a predetermined regular time interval.

12. The computer program product of claim 8, wherein the computer readable instructions further comprise:
an executable portion to access each of the management beans concurrently.

13. The computer program product of claim 8, wherein the computer readable instructions further comprise:
an executable portion to access each of the virtual machines concurrently.

14. The computer program product of claim 8, wherein the computer readable instructions further comprise:
an executable portion to, for each of the management beans accessed, store information indicating a time of access with the automated agent information and automated listener information.

15. A computer implemented method for enterprise-wide software monitoring using a Software Deployment Management (SDM) environment, the computer implemented method executed by one or more processing devices and comprising:
accessing a plurality of virtual machines running within the enterprise;
determining a plurality of applications running in each of the plurality of virtual machines;
accessing each of a plurality of management beans provided by each of the plurality of applications in each of the plurality of virtual machines, wherein the management beans a store information related to the automated agents and automated listeners of the plurality of applications;
identifying each of the management beans by name and operation;
parsing each of the management beans to determine associated automated agent information and automated listener information, wherein automated agent information is information related to automated background tasks occurring within the applications and automated listener information is information related to automated processes that wait for an event to occur; and
storing the automated agent information and automated listener information in an accessible database,
wherein the management beans are accessed and the automated agent information and automated listener information is determined absent loading of a Systems Management Application (SMA) of the SDM.

16-17. (canceled)

18. The computer-implemented method of claim 15, further comprising:
accessing each of the management beans periodically and based on a predetermined regular time interval.

19. The computer-implemented method of claim 15, further comprising:
accessing each of the management beans substantially concurrently; and
accessing each of the virtual machines concurrently.

20. The computer-implemented method of claim 15, further comprising:
for each of the management beans accessed, storing information indicating a time of access with the automated agent information and automated listener information.
